(19) United States
(12) Patent Application Publication
(10) Pub. No.: US 2014/0291278 A1
(43) Pub. Date: Oct. 2, 2014

(54) METHOD FOR THE PRODUCTION OF MARKED VIALS, MARKED VIAL PRODUCTION CHAIN AND MARKED VIALS

(71) Applicant: Marie-Aude Gudin De Vallerin, Amiens (FR)

(72) Inventors: Patrick Colin, Amiens (FR); Edouard Gudin De Vallerin, Amiens (FR)

(73) Assignee: UITHER DEVELOPPEMENT, Amiens (FR)

(21) Appl. No.: 13/884,056

(22) PCT Filed: Nov. 8, 2011
(86) PCT No.: PCT/FR2011/052601

§ 371 Date: Apr. 16, 2014

(30) Foreign Application Priority Data
Nov. 8, 2010 (FR) 10 59200

(51) Int. Cl. B65B 3/00; A61J 1/00; B65B 3/02; B65D 25/00; B65B 7/28; B65B 61/02

(52) U.S. Cl. CPC B65B 3/003; B65B 7/2842; B65B 61/025; B65B 3/022; B65D 25/00; A61J 1/00
USPC 215/365; 53/411; 53/131.4

(57) ABSTRACT

A method for the production of a single-dose-type marked vial (10) intended, in particular, to receive a product (22) for pharmaceutical or cosmetic uses includes the following steps: production of a vial (10) including a cavity that is intended to receive the product (22); filling of the vial with the product (22) and sealing thereof, separate production of a cover (30), and marking (40) of the cover (30). The associated production chain and the resulting vial are also described.

This invention relates to a method for the production of marked vials, in particular vials of products with an expiration date, and more particularly vials of pharmaceutical products or cosmetic products.

It is thus that there exists on the market vials intended more particularly for the packaging of pharmaceutical products, in the form of solutions, gels, and suspensions.

These vials are thus named because they have generally very limited volumes, containing a single dose of product.

This makes it possible to package products in a sterile manner, in small packages, easy to open and very easy to use.

The method consists in forming containers, filling them in a stream, and sealing them after they are filled, in a sterile environment.

This technology is very well known and absolutely tried and true.

The single-dose containers are combined with one another, right during production, into series to have in general a set of doses forming a strip, with the user detaching one of these single doses upon use.

There are numerous applications, for example:
Eyewash,
Rhinology products,
Physiological serum,
Antiseptics,
Products for treating asthma,
Cosmetic products.

The volume of these single doses is on the order of 0.2 to 5 ml.

These vials offer the advantage of making possible the provision of fractionable liquid products, in a sterile manner.

Because of the single-dose, i.e., disposable, packaging, the addition of one or more preservatives is unnecessary.

The product is easily transportable, safe, no bottles, no large volumes, and very high packaging strength because of the wall thickness/volume ratio.

Such packaging comprises, in a known way:
A flat, quite rigid lower part, forming a pallet that is intended for handling by the user and for identification of the product because the body of the vial often has inadequate surface area for performing this function,
A volumetric body intended to accommodate and to contain the liquid or viscous fluid,
A seal that is produced with the body after filling, generally hot-formed. This seal is pre-scored, facilitating opening by detachment, twisting or folding and removal of said plug.

Actually, these containers generally consist of plastic material, generally of polyethylene or polypropylene. The production method by blowing extrusion consists in using an extruded parison, in positioning it in a mold in the shape of the container that is to be obtained, in closing the mold, in blowing to form the body of this container that assumes the shape of the mold, in filling this thus formed container immediately after blowing, and then in sealing the head of this body.

All of the stages of the method are placed in a sterile environment.

The method can be continuous, in a carrousel or intermittent; the stages remain identical.

The methods for producing, for filling, and the numerous advantages are established, and all of this does not pose any problem.

In contrast, it is proven that the marking of these vials is a real problem.

Actually, it is necessary to mark these vials as much for identifying the product, which constitutes a constant permanent marking, as for associating with the product an expiration date, a “use by” date, a lot number, or any other so-called variable marking.

In a general way, the permanent and variable markings are both added to a label, affixed on the vial.

This label is generally affixed to the flat part that is provided for gripping, because the application is easier and has a better hold.

The label is generated in parallel by any suitable means such as a printer and is affixed to the vial, on a chain.

Another means is the tampography or inkjet printing that consists in affixing, directly on the plastic material of the container, the desired notice.

It is also possible to mark the label that is already affixed to the vial and that bears the permanent notice by heat transfer so as to complete the permanent notice already printed on the label by the variable notice linked to the contents.

It is also understood that the affixing of labels is not always satisfactory, and health entities, for certain types of products, desire that the notices be engraved on each vial. The label can be degraded, removed, and replaced for acts of malice or else the compounds of inks and/or glues may possibly migrate.

This engraving therefore can be done only at the time it goes into the mold unless uptake after filling is provided, which quickly becomes problematic: possibility of heating of the contents of the vial, handling, risk of errors.

In this case, the known means consists in providing printing characters to be introduced into suitable receptacles and stored in the mold itself.

The operation is painstaking, difficult, and primarily extremely long and tedious.

This can be conceivable on the molds of an intermittent device because of a reasonable number of molds, 1 to 2 molds each comprising 20 to 48 imprints to be designed from individual printing characters.

In contrast, this cannot be considered on machines that work continuously, which comprise up to 375 imprints.

It is not economically feasible to put the molds and the line on standby during the insertion of the characters.

In addition, the risk of error is all the greater when there are characters to insert.

However, a lot with an error can compromise a production run, which is not acceptable and would not be very professional.

The choice is therefore relatively simple: either productivity is reduced by the use of low-speed devices, or the investment is high because it is necessary to invest in a series of molds per product, or close to 15 molds.

In addition, it is noted that even if there is a series of molds per product, it is necessary all the same to modify the variable notices, prior to each change in product.

Another approach that is described in the patent WO 2004/113054 proposes marking the vials in a stream, as they emerge from production.

For this purpose, each vial of each strip of vials produced, filled and sealed therefore has a flat part that is intended for gripping and/or for handling the part that is sealed for facilitating the opening.

It is on one of these flat parts that it is provided to affix the marking.

The device comprises means for accommodating vials in strips, hot-engraving means of each of the vials of the same strip and pressing means of the hot-engraving means opposite the surfaces to be marked.

It is a device that is separate and that can therefore be controlled independently of the blowing/filling/sealing chain.

In addition, it is understood that it is a simple engraved plate, which is quite different from an extrusion/engraved blowing mold.

The speed can be very fast and adapted to that of the production of vials in strips.

The change in plates is very simple, truly as in a printer, although the replacement of plates with each change in the product is done for the most part in the background.

Nevertheless, this solution is not yet satisfactory, because it touches on the integrity of the finalized vial whose material that constitutes it is heated, in particular.

The marking is of more or less good quality and is to be adapted to the geometry of the surface that receives this marking.

The surface can result from a hot function of two walls of the blown container, and the hot-marking may be imprecise in particular because of the vacuum between these two walls and the elasticity that results therefrom, which is not satisfactory.

This invention proposes a marking method that avoids affecting the integrity of the vials and that is adapted to the speed of the devices for production of vials, which benefits from quality marking, which is industrially acceptable, which eliminates any possible migration of compounds of the inks and/or glues, which guarantees a non-interchangeability and therefore prohibits acts of malice, and which preserves and even improves gripping and handling of said vials.

This invention is now described relative to the accompanying drawings that show a particular, preferred but non-limiting, embodiment, with these figures corresponding to:

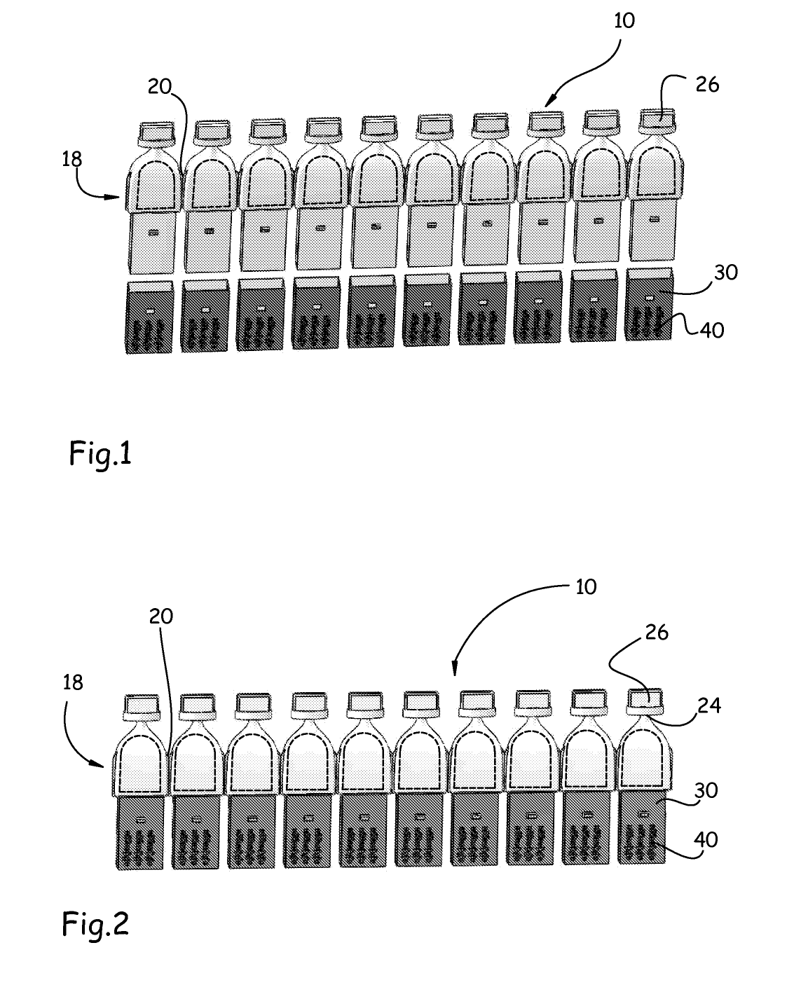

FIG. 1: A view of vials in a strip according to the invention before finalization,

FIG. 2: A view of vials of FIG. 1, after finalization,

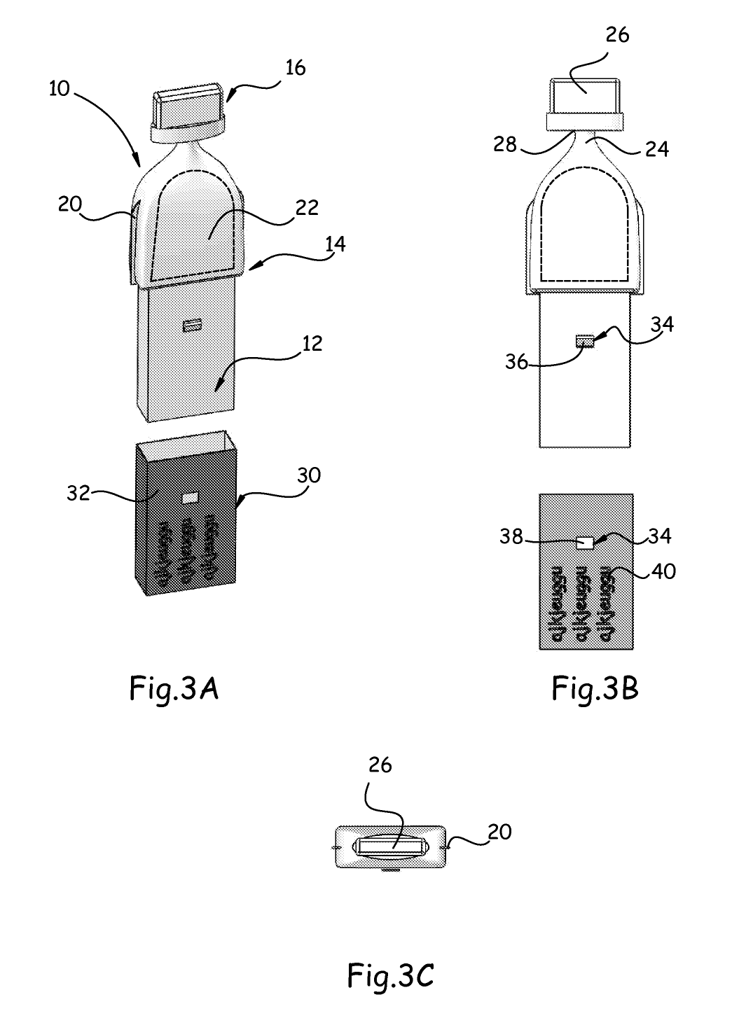

FIGS. 3A, 3B, 3C: A detail view of a vial according to the invention and its covering, before insertion, respectively in perspective from the top, front and bottom,

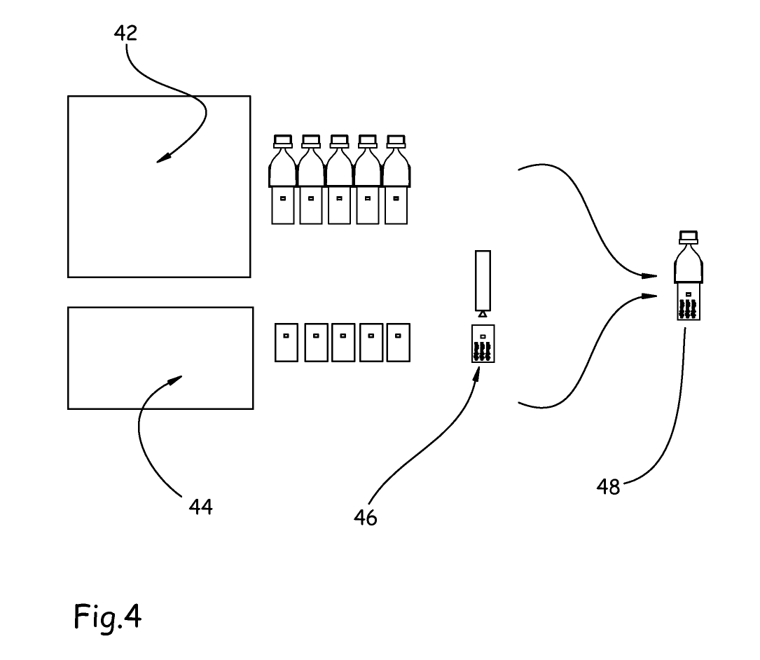

FIG. 4: A diagrammatic view of a vial production station according to this invention,

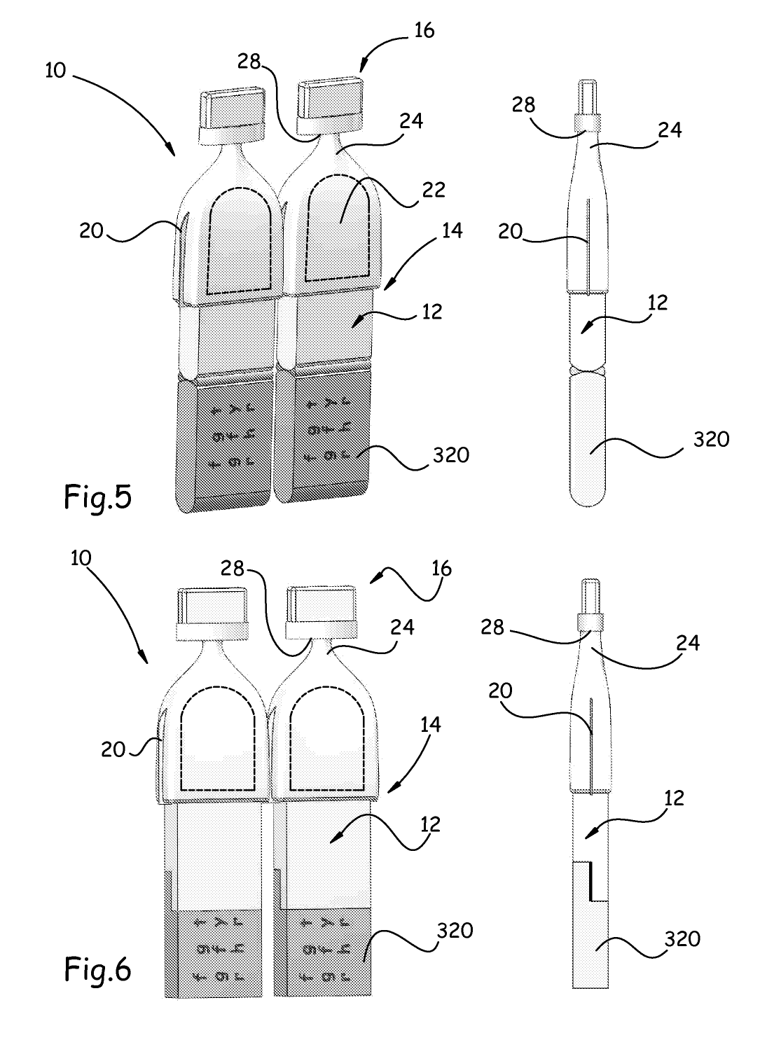

FIG. 5: A view of a variant embodiment of the covering in the form of a welded tab, with connection to the edges, and

FIG. 6: A view of a variant embodiment of the covering in the form of a welded tab, with partial superposition.

The vials 10 according to this invention are made by blowing extrusion, filling in a stream, and sealing thereafter, in a sterile environment when the product requires it. With the method and the device being known, the description is no longer shown.

The vials are generally presented in a strip as in FIGS. 1 and 2 comprising 10 to 12 vials.

Each vial, see FIG. 3, comprises a base 12, a body 14, and a head 16.

The base 12 results from a hot-plating of the walls of the container in such a way as to produce a surface, in this case a flat one, rectangular, with a thickness that is approximately equal to twice the thickness of the wall of the container or a smaller thickness based on the initial volume that is used and the surface that is generated from this volume.

These vials 10 are linked to form a strip 18; in this case, they are linked by their sides, by means 20 for connecting in the form of shoulders.

These connecting means 20 are suitable for making the connection detachable, by breaking the link opposite the shoulders, thus making it possible to remove one of the end vials, with the others remaining linked.

The body 14, of small volume, is hollow for accommodating the product 22, in the form of liquid, gel or solution, for example.

The volume is preferably adapted to the general shape of the container, and it is noted that the geometry of the body is a bit flattened in the embodiment that is shown.

The head 16 has come from production after filling and results from a hot deformation of the upper part of the container.

This head 16 comprises a neck 24, a cap 26, and a weakening point 28 between the two for ensuring an easy removal of said head and for accessing the product. This weakening point 28 is broken, often by rotation of the cap 26 relative to the neck 24. The neck is then open opposite the weakening point and allows the product to flow by inverting the vial and generally by pressure on the body because the liquid can be held by capillary action in said body because of the small volume.

During this operation, the vial 10 is held by the user by its base 12.

This invention, in its first embodiment, consists in providing a covering 30 that is intended to work with at least one part of the vial 10.

More particularly, this invention proposes a covering 30 in the form of an enveloping cap 32, intended to work by interlocking with the base 12 of said vial.

This cap 32 in this case has an inside profile mated to the outside profile of the base 12 to allow their permanent interlocking.

Means 34 for connecting between the vial 10 and more particularly, in the embodiment shown, between the base 12 and the covering 30, i.e., the cap 32, are also provided.

These connecting means can be mechanical or by welding, in particular of the ultrasonic-welding type.

A mechanical means consists in, for example, at least one lug 36 that is made on the surface of the base 12 forming a barb and at least one receptacle 38 intended to accommodate the lug, with a profile mated to, in this case, a window. Such an arrangement makes possible the interlocking of the cap 32 on the base 12 and the cooperation of the lug 36 with the receptacle 38, knowing that the profile of the barb prevents its removal unless the elements are degraded.

In an advantageous way, one lug/receptacle pair is provided per surface.

Each cap can accommodate a marking 40 on its external surface, by any arbitrary means:
Mechanical engraving, thermal engraving by hot matrix or laser engraving, or
Marking with ink by tampography, by laser printing.

This can be quality marking because there is no interference with the vial itself and even less with its contents, eliminating any possible migration problem.

The caps are produced in parallel and positioned on the vials that are filled and sealed, downstream from the production of said vials.

It is noted that the caps do not have to be in a sterile environment since there is no contact with the contents of each vial.

The vials can therefore be produced in a standard way as well as the caps, the latter being marked simultaneously to the production of vials and to the filling with the product corresponding to marking.

In contrast, the interlocking can be done at the outlet, in a location lacking in sterility.

So as to make possible an improved distinction of vials of different products, it is possible to personalize the colors. Opaque colors also make possible better legibility of the markings.

The very nature of the materials used for the production of the caps can be of a nature that is different from that of the vials.

Thus, it is possible to use recycled materials or new materials but with improved qualities of biodegradability and/or recyclability.

Likewise, the mechanical properties can be different, and in particular the polymer material that is used can be rigid.

The selection of material can also ensure an improvement in the quality of marking and therefore its final legibility.

The caps are preferably produced by injection, which is a less costly means, with high productivity and great precision.

The injection molds can be engraved with permanent notices, such as a logo, for example, although the only thing that remains is to provide the variable notices on the caps by the means indicated above.

The blowing extrusion device therefore needs only one set of molds for the production of a vial model that is capable of accommodating different products, with the identification being independent of the vial itself.

The invention therefore proposes a complete vial that comprises a covering over at least a portion of its volume.

The production chain necessary for the production of a complete vial according to the invention therefore comprises at least one station 42 for forming/filling/sealing vials, in parallel a station 44 for producing coverings, a station 46 for marking coverings, and a station 48 for positioning thus marked coverings on said vials.

The station 42 is a station that works by extrusion/blowing/filling. The station 44 is an injection/molding station.

The marking station 46 is a station for marking by mechanical engraving, by thermal engraving with a hot matrix or by laser engraving, or else marking with ink by tampography or by laser printing.

The mounting station 48 makes possible an interlocking of bases 12 of vials 10 in the caps 32.

FIG. 5 showed a second embodiment, technical equivalent of the first embodiment.

Actually, in this case, the covering 30 consists only of a tab 320 instead of a cap 32.

This tab 320 can be produced by taking advantage of the same wide fan of materials with the set of advantages indicated above for the cap 32.

The tab can be colored; the tab can be marked by any means, marking with ink or engraving.

The production of this tab is strictly identical, on a separate chain, with marking of the notices that are necessary.

The means 34 for connecting this tab with the base 12 of the vial 10 are of the edge welding type, in particular by ultrasound, between the proximal edge of the base, preferably short, and the proximal edge of the tab 320. This is even more visible in the view associated with FIG. 5, the view being a lateral front view.

The welding can also be done by a partial superposition of the surfaces of the tab and the base.

In this case, it is possible, as shown in FIG. 6, to provide respective offsets at mid-thickness in such a way as to prevent any projection.

It is noted that this welding does not cause any heating of the contents of the vial because ultrasonic welding is an operation with a very low input of heat, on the one hand, is extremely focused, on the other hand, and primarily is produced in a zone that is away from the body of the vial since it starts from the free edge of the base 12.

Likewise, execution of the welding can be done with a partial superposition of the tab 320 and the base 12, with the welding being on the surface, at mid-thickness, as shown in FIG. 6.

In this case, to limit the thickness and primarily to prevent any projection of any edge, the base 12 comprises a thinning and the tab 320 also in such a way that the superposition of the two elements opposite the surface junction zone is of a constant thickness. This is shown in the view associated with FIG. 6, in a side view for a better appreciation.

In one variant or in the other, the method therefore consists of the series of the following stages:
Production of a vial that comprises a product volume,
Filling and sealing of said vial,
Separate production of a covering,
Marking of the covering,
Production of connecting means between the vial and the covering,
Permanent interlocking of the covering and the vial.

It is understood that that which is described for a vial can be reproduced identically for a strip of vials.

It is noted that the coverings of each of the vials of one strip are not necessarily linked to one another, only the vials being so.

The interlocking is to be permanent, i.e., disassembly can be performed only by at least partial destruction of the vial and/or the covering.

It is understood that what was presented as a cap with an essentially rectangular cross-section can take the shape of a ring; in the same way on a vial with a circular cross-section, the cap of the container can comprise a central holding lug of a cap that is also of cylindrical shape, comprising a recessed pipe intended to accommodate said lug.

Likewise, the connecting means can consist of a surface state of the base and the interior of the coverings of the flake type that make possible an introduction of the covering on the vial and prevents its removal.

Likewise, it is possible to select a ring, marked separately with a groove that is intended to accommodate said ring, with the edges of the grooves preventing the removal of said ring once it is mounted.

Finally, the interlocking can be of the simple type, with zero-force introduction, followed by an ultrasonic welding of the cap on the vial.

It is suitable in the embodiment adopted to provide that the covering be integrated with the vial and not project since it otherwise may cause unhooking or tearing-away by force, and therefore degradation of the vial.

1. Method for the production of a marked vial (10), of the single-dose type, in particular intended to accommodate a product (22) for pharmaceutical or cosmetic applications, characterized in that it comprises the following stages:
Production of a vial (10) comprising a volume that is intended to accommodate the product (22),
Filling the vial with the product (22) and sealing said vial,
Separate production of a covering (30),
Marking (40) of the covering (30),
Production of connecting means (34) between the vial (10) and the covering (30).

2. Method for the production of a marked vial according to claim 1, wherein the connecting means (34) between the vial (10) and the covering (40) are produced simultaneously to the production of said vial and said covering.

3. Method for the production of a marked vial according to claim 1, wherein with the covering (30) being a cap (32), a permanent interlocking of said cap (32) and the vial (10) is initiated.

4. Method for the production of a marked vial according to claim 3, wherein the permanent interlocking stage includes welding.

5. Method for the production of a marked vial according to claim 1, wherein with the covering (30) being a tab (320), welding of said tab (320) and the vial (10) is initiated.

6. Method for the production of a marked vial according to claim 1, wherein the operations for production of the vial (10) and the covering (30) are conducted in parallel so as to make possible an interlocking directly during production.

7. Method for the production of a marked vial according to claim 1, wherein it is applied to a strip of vials linked to one another to form a strip (18).

8. Production chain making possible the implementation of the method according to claim 1, wherein it comprises at least one station (42) for forming/filling/sealing vials, in parallel a station (44) for producing coverings (30), a station (46) for making coverings, and finally a station (48) for positioning coverings that are thus marked on said vials.

9. Production chain according to claim 6, wherein the station (42) is a station working by extrusion/blowing/filling, and the station (44) is an injection/molding station.

10. Marked vial, of the single-dose type, in particular for pharmaceutical or cosmetic applications, wherein it comprises a base (12), a body (14) and a head (16), as well as a covering (30) that is integral with said base (12) and connecting means (34) between the base (12) and said covering (30).

11. Vial according to claim 10, wherein the body (14), of small volume, is hollow for accommodating the product (22), in the form of liquid, gel, suspension or solution.

12. Vial according to claim 10, wherein the base (12) results from a hot-plating of the walls of the container in such a way as to produce a surface, in this case a flat one, rectangular, with a thickness that is approximately equal to twice the thickness of the wall of the container.

13. Vial according to claim 10, wherein the connecting means (34) between the base (12) and the covering (30) consist of at least one lug (36) that is made on the surface of the base (12) forming a barb and at least one receptacle (38) intended to accommodate the barb, with a mated profile.

14. Vial according to claim 10, wherein the base (12) is short and accommodates the tab (320) by edge welding.

15. Vial according to claim 10, wherein the base (12) accommodates the tab (320) by surface welding and presentation at mid-thickness.

16. Strip (18) of vials according to claim 10, wherein the vials (10) comprise connecting means (20) between them.

17. Method for the production of a marked vial according to claim 2, wherein with the covering (30) being a cap (32), a permanent interlocking of said cap (32) and the vial (10) is initiated.

18. Method for the production of a marked vial according to claim 2, wherein with the covering (30) being a tab (320), welding of said tab (320) and the vial (10) is initiated.

19. Vial according to claim 11, wherein the base (12) results from a hot-plating of the walls of the container in such a way as to produce a surface, in this case a flat one, rectangular, with a thickness that is approximately equal to twice the thickness of the wall of the container.

20. Vial according to claim 12, wherein the connecting means (34) between the base (12) and the covering (30) consist of at least one lug (36) that is made on the surface of the base (12) forming a barb and at least one receptacle (38) intended to accommodate the barb, with a mated profile.
